(19) United States
(12) Patent Application Publication
(10) Pub. No.: US 2014/0080105 A1
(43) Pub. Date: Mar. 20, 2014

(54) LEARNING SUPPORT DEVICE, LEARNING SUPPORT METHOD AND STORAGE MEDIUM CONTAINING LEARNING SUPPORT PROGRAM

(71) Applicant: CASIO COMPUTER CO., LTD., Tokyo (JP)

(72) Inventor: Kazuhisa NAKAMURA, Tokyo (JP)

(73) Assignee: CASIO COMPUTER CO., LTD., Tokyo (JP)

(21) Appl. No.: 14/026,790

(22) Filed: Sep. 13, 2013

(30) Foreign Application Priority Data
Sep. 14, 2012 (JP) 2012-202364

(51) Int. Cl. G09B 19/02

(52) U.S. Cl. CPC G09B 19/02
USPC 434/191

(57) ABSTRACT

A learning support device includes a storage unit, first display control unit, detecting unit and second display control unit. The storage unit stores identifying items to identify the type of a word problem which are detectable in the text of the word problem, and stores at least one relation between variables in the identified-type word problem, for each type of the word problem. The first display control unit displays the word problem requiring calculation of an unknown variable from known variables in the text. The detecting unit detects each identifying item in the text of the displayed word problem. The second display control unit reads out a relation about the unknown variable among the relation(s) for the identified-type word problem, and displays the read-out relation as a corresponding relation.

### BACKGROUND OF THE INVENTION

1. Field of the Invention

The present invention relates to a device and a method of supporting study of word problems, and a storage medium containing a learning support program.

2. Description of the Related Art

A conventional learning support device for arithmetic stores a solution to each word problem (i.e., a problem expressed in sentences) in advance and displays hints on a solution corresponding to an answer input by a user.

Unfortunately, the conventional technique involves troublesome processes of storing a solution to each problem. Furthermore, the conventional device is inconvenient because it cannot display hints on a solution which is not stored in the device.

### SUMMARY OF THE INVENTION

An object of the present invention is to provide a learning support device, a learning support method and a storage medium containing a learning support program which can support the study of word problems more efficiently compared with the conventional ways.

According to an aspect of the present invention, there is provided a learning support device including: a storage unit which stores a plurality of identifying items to identify a type of a word problem, the identifying items being detectable in a text of the word problem, and stores at least one relation between variables in the word problem, the type of which is identified by the identifying items, the storage unit storing the identifying items and the at least one relation for each type of the word problem; a first display control unit which displays the word problem requiring calculation of an unknown variable not specified in the text from known variables specified in the text; a detecting unit which detects each of the identifying items in the text of the word problem displayed by the first display control unit; and a second display control unit which reads out, from the storage unit, a relation about the unknown variable among the at least one relation for the word problem, the type of which is identified by the identifying items detected by the detecting unit, and which displays the read-out relation as a corresponding relation.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram illustrating functional components of a display terminal;

FIG. 2 illustrates a diagram template table;

FIG. 3 illustrates a flow chart of a learning support process;

FIG. 4 illustrates the continuation to the flow chart of FIG. 3;

FIG. 5 illustrates the continuation to the flow chart of FIG. 4;

FIG. 6 illustrates the continuation to the flow chart of FIG. 5;

FIG. 7A illustrates the content appearing on a display;

FIG. 7B illustrates the content appearing on a display;

FIG. 7C illustrates the content appearing on a display;

FIG. 7D illustrates the content appearing on a display;

FIG. 8A illustrates the content appearing on a display;

FIG. 8B illustrates the content appearing on a display;

FIG. 8C illustrates the content appearing on a display;

FIG. 8D illustrates the content appearing on a display;

FIG. 9A illustrates the content appearing on a display;

FIG. 9B illustrates the content appearing on a display;

FIG. 9C illustrates the content appearing on a display;

FIG. 9D illustrates the content appearing on a display;

FIG. 10A illustrates the content appearing on a display; and

FIG. 10B illustrates relations between diagram part parameters.

### DESCRIPTION OF THE PREFERRED EMBODIMENTS

Exemplary embodiments of the present invention will now be described in detail with reference to the accompanying drawings. The embodiments, however, should not be construed as limiting the scope of this invention.

### [Configuration]

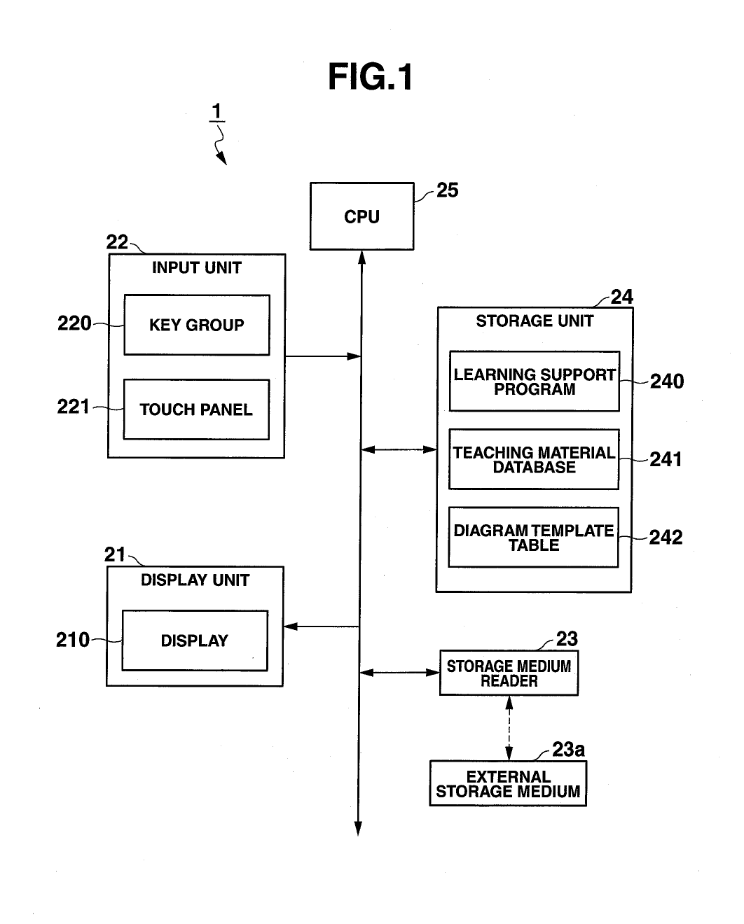

FIG. 1 is a schematic block diagram illustrating a display terminal 1 of the present embodiment.

The display terminal 1 of the present embodiment includes a display unit 21, an input unit 22, a storage medium reader 23, a storage unit 24, and a CPU 25, as illustrated in FIG. 1.

The display unit 21 includes a display 210 on which various information items are displayed on the basis of display signals sent from the CPU 25. The display 210 in the present embodiment is integrated with a touch panel 221 so as to sense a touch operation by a user.

The input unit 22 includes a key group 220 and the touch panel 221 and provides the CPU 25 with a signal corresponding to a depressed key or a touched position of the touch panel 221.

The storage medium reader 23 reads information out from an external storage medium 23a, such as an SD card, and allows information to be recorded on the external storage medium 23a.

The storage unit 24 stores programs and data for performing various functions of the display terminal 1 and serves as a work area for the CPU 25. The storage unit 24 in the present embodiment stores a learning support program 240, a teaching material database 241, and a diagram template table 242 according to the present invention.

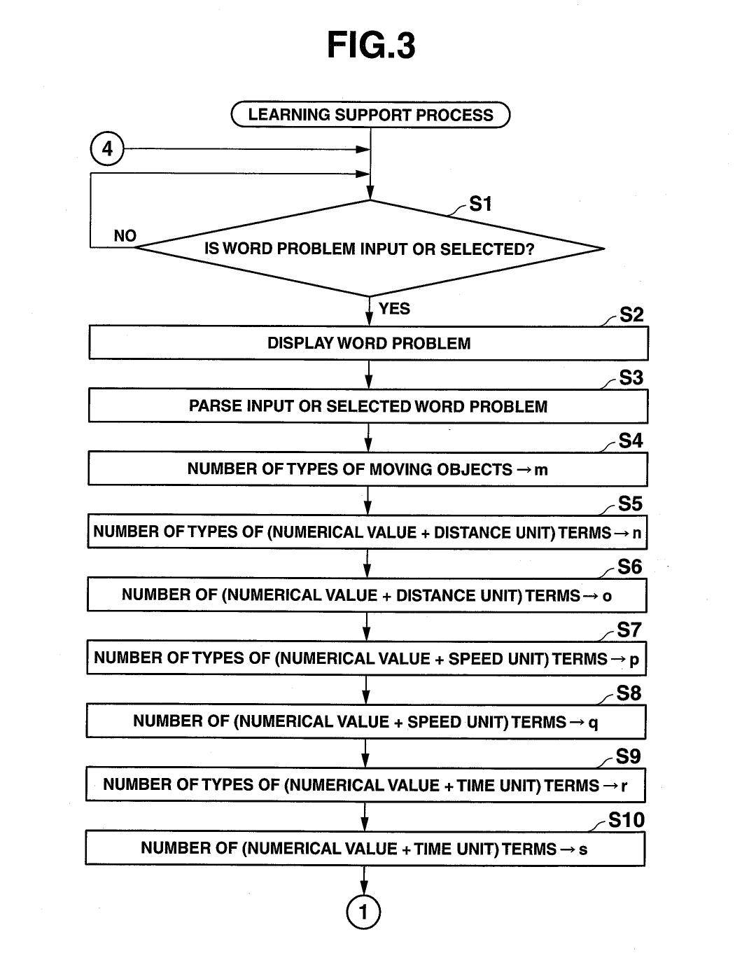

The learning support program 240 causes the CPU 25 to execute a learning support process described later (see FIGS. 3 to 6).

The teaching material database 241 contains a plurality of word problems related to, for example, arithmetic. The word problems each require a user to find an unknown variable, which is not specified in the text of the word problem, using known variables, which are specified in the same text.

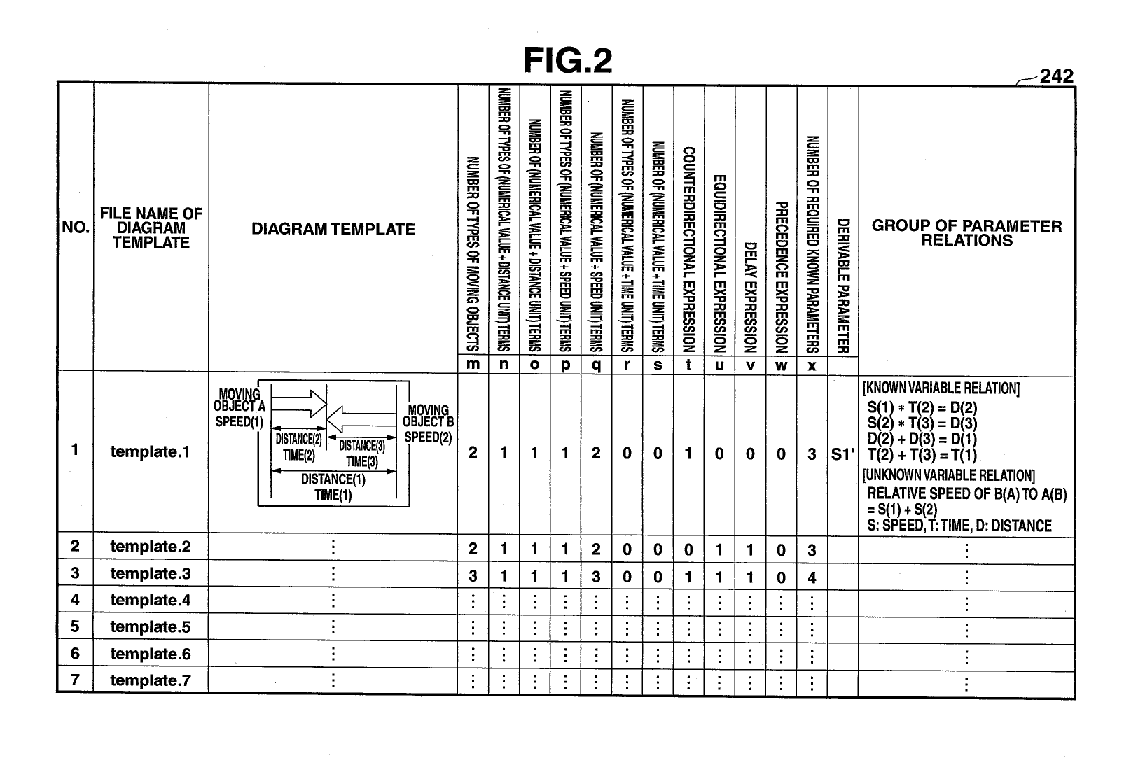

As illustrated in FIG. 2, the diagram template table 242 stores a set of a plurality of identifying items to identify the type of word problem (e.g., “type 1,” “type 2,” etc.), the identifying items being detectable in the text of a word problem; a diagram template diagrammatically representing the word problem, the type of which is identified by the set of identifying items; at least one relation (hereinafter, referred to as “diagram part parameter relation”) between parameters corresponding to diagram parts of the diagram template (hereinafter, referred to as “diagram part parameters”); and the number of known variables required for solving the word problem (hereinafter, referred to as “required known variables”), the type of which word problem is identified by the set of identifying items. The diagram template table 242 stores them in association with one another for each type of word problem.

The identifying items are to be detected from the text of any word problem for identification of the type of the word problem and include at least the number of quantitative expressions, the number of types of the quantitative expressions, and presence or absence of specific expressions specified in the text. They are denoted as values of variables “m” to “w” in the present embodiment. Specifically, the identifying items include the number of types of moving objects (variable “m”) in the text of a word problem, the number of types of [numerical value+distance unit] terms (variable “n”), the number of [numerical value+distance unit] terms (variable “o”), the number of types of [numerical value+speed unit] terms (variable “p”), the number of [numerical value+speed unit] terms (variable “q”), the number of types of [numerical value+time unit] terms (variable “r”), the number of [numerical value+time unit] terms (variable “s”), presence or absence of a counterdirectional expression (variable “t”), presence or absence of an equidirectional expression (variable “u”), presence or absence of a delay expression (variable “v”), and presence or absence of a precedence expression (variable “w”).

Examples of the distance unit include “meter (m)” and “kilometer (km).” Examples of the speed unit include “m per minute.” Examples of the time unit include “minute.”

The counterdirectional expression is a word or phrase which means that two or more moving objects reach the same position, including “meet.” The equidirectional expression is a word or phrase which means that two or more moving objects travel in the same direction, including “catch up with” and “pass.” The delay expression is a word or phrase which means that one moving object travels after another moving object, including “later.” The precedence expression is a word or phrase which means that one moving object travels before another moving object, including “ahead” and “earlier.” These counterdirectional, equidirectional, delay, and precedence expressions may be verbs or adverbs.

A diagram template diagrammatically represents a word problem, the type of which is identified by a set of identifying items, so that each of the known and unknown variables in the word problem can be associated with a diagram part parameter representing any one of the length, angle and area of a diagram part of the diagram template. Thus, the diagram part parameter relation indicates a relation between variables in an associated word problem. Note that examples of the diagram parts of the diagram template include sides, corners, and areas, and the “diagram parts of the diagram template” includes the entire diagram of the diagram template.

The CPU 25 comprehensively controls individual units of the display terminal 1. Specifically, the CPU 25 expands a program designated from system programs and various application programs stored in the storage unit 24, and executes one of various processes in cooperation with the expanded program.

### [Learning Support Process]

The learning support process executed by the display terminal 1 will now be described with reference to the drawings.

FIGS. 3 to 6 are flow charts illustrating the operation of the learning support process. The learning support program 240 is read out from the storage unit 24 and is appropriately expanded in response to an input of an instruction to execute the learning support process from a user through the input unit 22. The learning support process is thus executed with the learning support program 240 and the CPU 25 cooperating with each other.

As illustrated in FIG. 3, in the learning support process, the CPU 25 first determines whether a word problem is input or any word problem stored in the teaching material database 241 is selected according to user operations (step S1).

In step S1, if determining that no word problem is input or selected (step No), the CPU 25 repeats step S1.

In step S1, if determining that a word problem is input or selected (step S1: Yes), the CPU 25 displays the input or selected word problem on the display 210 (step S2). In the present embodiment, the displayed word problem requires calculation of speeds, times, and distances of multiple moving objects.

The CPU 25 then parses the text of the word problem (step S3) and sets a variable “m” to the number of types of moving objects in this text (step S4). The moving objects are “Taro” (a person's name), “Hanako” (a person's name), and “automobile”, for example. Note that the variable “m” may be set to the number of moving objects instead of the number of types of moving objects in step S4.

The CPU 25 then sets a variable “n” to the number of types of [numerical value+distance unit] terms in the text of the word problem (step S5).

The CPU 25 then sets a variable “o” to the number of [numerical value+distance unit] terms in the text of the word problem (step S6).

The CPU 25 then sets a variable “p” to the number of types of [numerical value+speed unit] terms in the text of the word problem (step S7).

The CPU 25 then sets a variable “q” to the number of [numerical value+speed unit] terms in the text of the word problem (step S8).

The CPU 25 then sets a variable “r” to the number of types of [numerical value+time unit] terms in the text of the word problem (step S9).

The CPU 25 then sets a variable “s” to the number of [numerical value+time unit] terms in the text of the word problem (step S10).

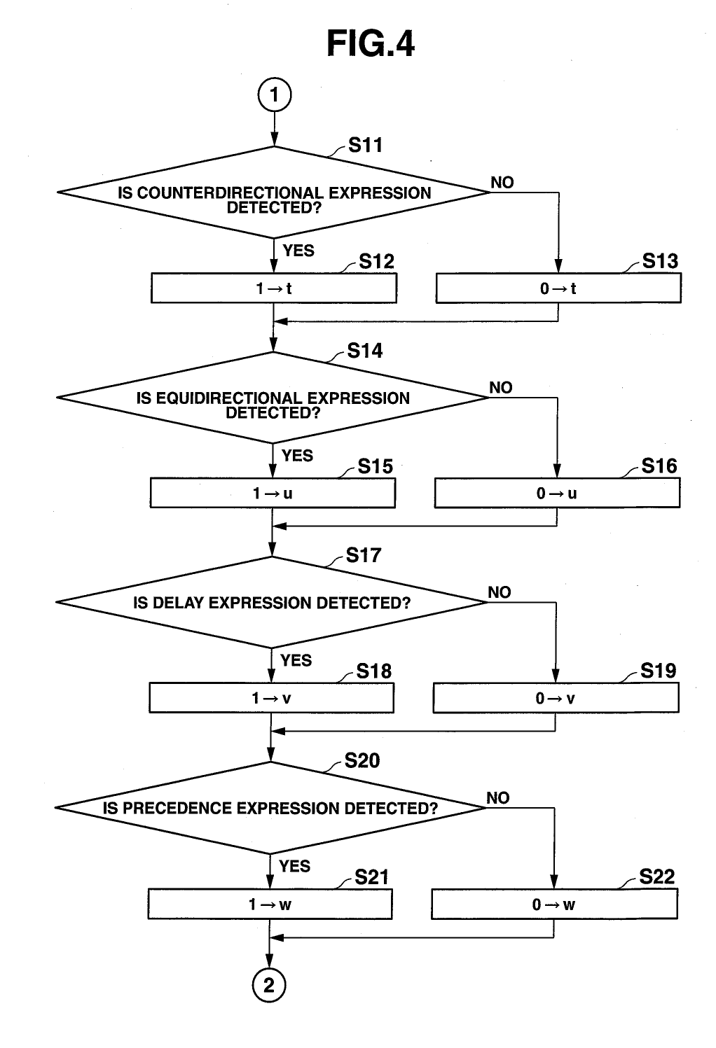

Next, as illustrated in FIG. 4, the CPU 25 determines whether a counterdirectional expression is included in the text of the word problem (step S11). If determining that the counterdirectional expression is included (step S11: Yes), the CPU 25 sets a variable “t” to “1” (step S12) and advances the process to step S14 described below.

In step S11, if determining that no counterdirectional expression is included (step S11: No), the CPU 25 sets the variable “t” to “0” (step S13).

The CPU 25 then determines whether an equidirectional expression is included in the text of the word problem (step S14). If determining that the equidirectional expression is included (step S14: Yes), the CPU 25 sets a variable “u” to “1” (step S15) and advances the process to step S17 described below.

In step S14, if determining that no equidirectional expression is included (step S14: No), the CPU 25 sets the variable “u” to “0” (step S16).

The CPU 25 then determines whether a delay expression is included in the text of the word problem (step S17). If determining that the delay expression is included (step S17: Yes), the CPU 25 sets a variable “v” to “1” (step S18) and advances the process to step S20 described below.

In step S17, if determining that no delay expression is included (step S17: No), the CPU 25 sets the variable “v” to “0” (step S19).

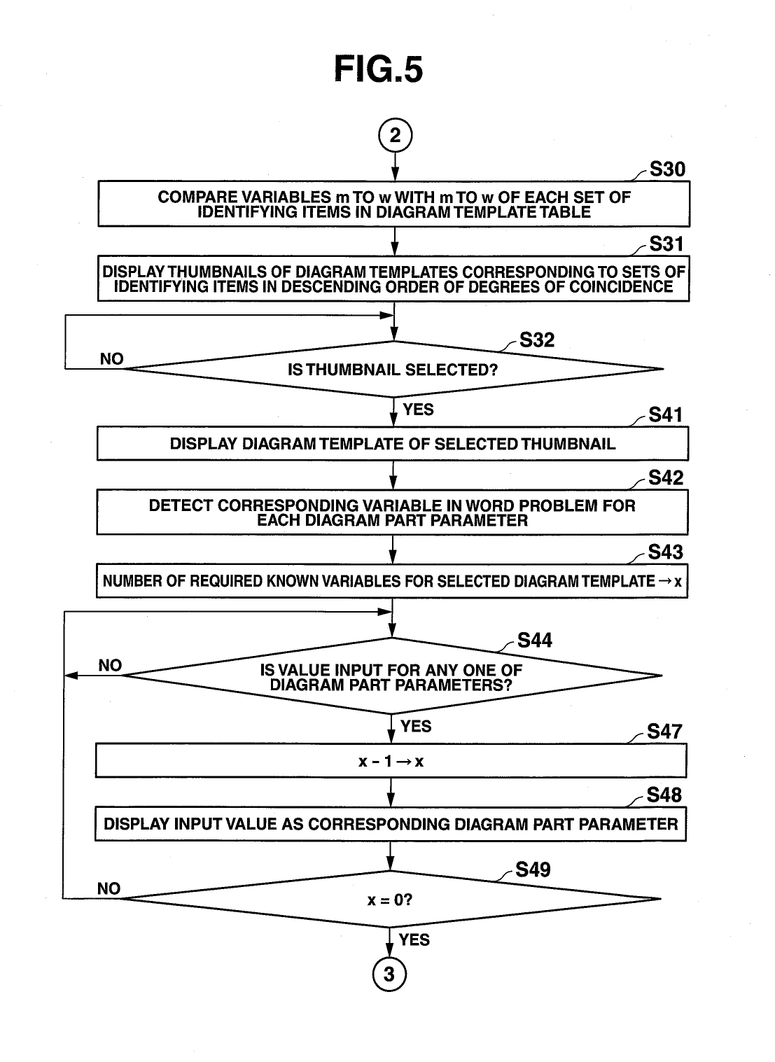

The CPU 25 then determines whether a precedence expression is included in the text of the word problem (step S20). If determining that the precedence expression is included (step S20: Yes), the CPU 25 sets a variable “w” to “1” (step S21) and advances the process to step S30 (see FIG. 5).

In step S20, if determining that no precedence expression is included (step S20: No), the CPU 25 sets the variable “w” to “0” (step S22).

Next, as illustrated in FIG. 5, the CPU 25 compares the variables “m” to “w” set in steps S4 to S22 with each set of variables “m” to “w” preliminarily stored as identifying items in the diagram template table 242 in association with the corresponding type of word problem. (step S30).

The CPU 25 then extracts some of the sets of identifying items from the diagram template table 242 in descending order of the degrees of coincidence with the variables “m” to “w” set in steps S4 to S22. The CPU 25 then allows the display 210 to display the thumbnails of the diagram templates corresponding to the extracted sets of identifying items in the order of the extraction (step S31). Alternatively, the CPU 25 may allow the display 210 to display only the thumbnail of the diagram template corresponding to a set of identifying items having the highest degree of coincidence with the variables “m” to “w” set in steps S4 to S22.

The CPU 25 then determines whether one of the thumbnails is selected according to user operations (step S32); if determining that a thumbnail is not selected (step S32: No), the CPU 25 repeats step S32.

In step S32, if determining that a thumbnail is selected (step S32: Yes), the CPU 25 allows the display 210 to display the diagram template of the selected thumbnail (hereinafter, referred to as “corresponding diagram template”) (step S41).

The CPU 25 then detects, among the known variables in the word problem, a known variable corresponding to a diagram part parameter for each diagram part parameter in the corresponding diagram template (step S42). For example, the CPU 25 determines the known variables in the word problem and the types of the known variables on the basis of the parsing in step S3, detects the values of a distance and a time in the word problem as diagram part parameters that represent the length of a two-directional arrow in the corresponding diagram template, and detects the value of a speed in the word problem as a diagram part parameter that represent the length of a left- or right-pointing arrow in the corresponding diagram template.

The CPU 25 then reads out the number of required known variables associated with the corresponding diagram template from the diagram template table 242 and sets a variable “x” to the read-out number (step S43).

The CPU 25 then determines whether any one of the diagram part parameters in the corresponding diagram template is defined as a known parameter and whether the value of the known parameter is input according to user operations (step S44). If determining that these operations are not performed (step S44: No), the CPU 25 repeats step S44.

In step S44, if determining that the above operations are performed (step S44: Yes), the CPU 25 subtracts “1” from the variable “x” (step S47) and then allows the display 210 to display the input value as the diagram part parameter (step S48).

The CPU 25 then determines whether the variable “x” is “0” (step S49). If determining that “x” is not “0” (step S49: No), the CPU 25 returns the process back to step S44.

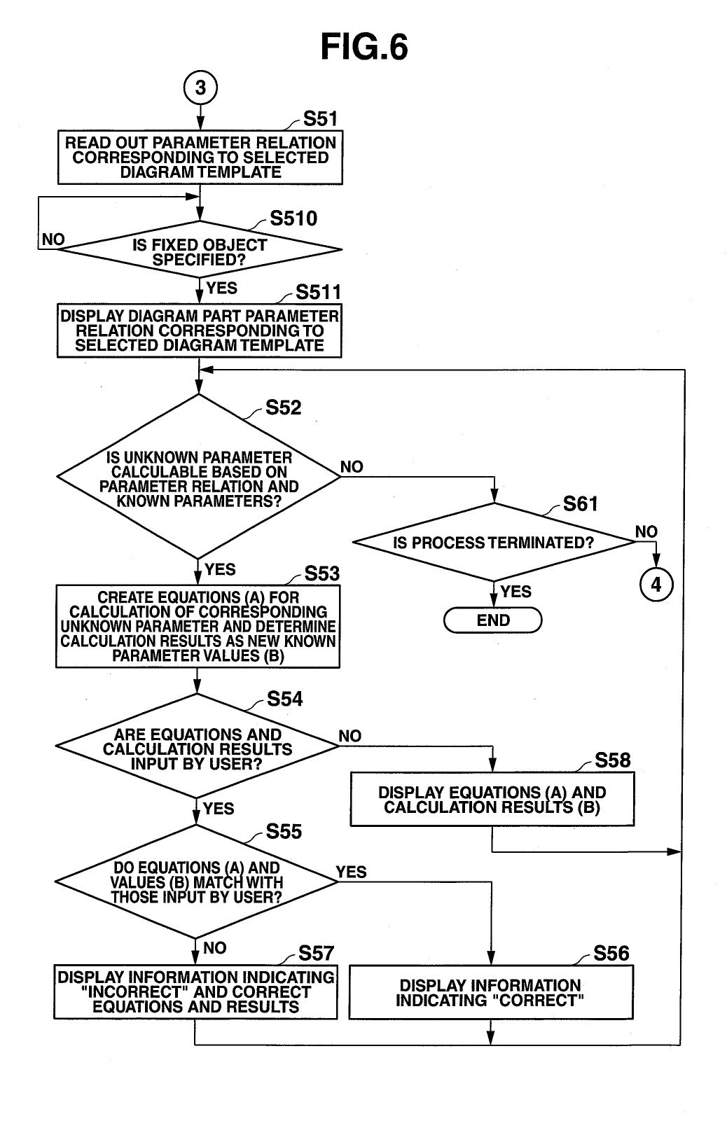

In step S49, if determining that “x” is “0” (step S49: Yes), the CPU 25 reads outs the diagram part parameter relations for the corresponding diagram template from the diagram template table 242, as illustrated in FIG. 6 (step S51).

The CPU 25 then determines whether any one of the moving objects in the text of the word problem is specified as a fixed object according to user operations (step S510). If determining that this operation is not performed (step S510: No), the CPU 25 repeats step S510.

In step S510, if determining that the operation is performed (step S510: Yes), the CPU 25 determines the specified moving object in the text as a fixed object and the rest of the moving objects as non-fixed object(s), reads out a relation stored in the diagram template table 242 and associated with unknown variables in the word problem among the diagram part parameter relations of the corresponding diagram template, and allows the display 210 to display the read-out relation as a corresponding diagram part parameter relation (step S511). The CPU 25 also changes the speed value of the fixed object to zero, changes the speed value (s) of the non-fixed object (s) to a value (s) obtained as the relative speed (s) of the non-fixed object(s) to the fixed object, and accordingly changes the corresponding diagram part parameter relation for display. The corresponding diagram part parameter relation displayed in step S511 will be used by the user as hints on the solution to the word problem.

The CPU 25 then determines the calculability of an unknown diagram part parameter among the diagram part parameters in the corresponding diagram part parameter relation based on the known parameters corresponding to the respective diagram parts in the corresponding diagram template and the diagram part parameter relation (step S52).

In step S52, if determining that the unknown diagram part parameter can be calculated (step S52: Yes), the CPU 25 determines the unknown diagram part parameter as a calculation target and substitutes the current known parameters in the diagram part parameter relation associated with the corresponding diagram template to deform the relation into equations (hereinafter, referred to as “equations (A)”) for the calculation of the calculation target. The CPU 25 then calculates the calculation target (hereinafter, referred to as “value (B)”) on the basis of equations (A) (step S53). As a result, the diagram part parameter of the calculation target is a known parameter, value (B).

The CPU 25 then determines whether equations for the calculation of the diagram part parameter of the calculation target and calculation results are input according to user operations (step S54).

In step S54, if determining that the input operation is performed (step S54: Yes), the CPU 25 determines whether the input equations and results match with equations (A) and value (B), respectively (step S55).

In step S55, if determining that they match with equations (A) and value (B), respectively (step S55: Yes), the CPU 25 allows the display 210 to display information that the input equations and results are correct (step S56), and returns the process back to step S52.

In step S55, if determining that they do not match with equations (A) and value (B), respectively (step S55: No), the CPU 25 allows the display 210 to display information that the input equations and results are incorrect and also display equations (A) and value (B) as the correct equations and results (step S57). The CPU 25 then returns the process back to step S52.

In step S54, if determining that the input operation is not performed (step S54: No), the CPU 25 allows the display 210 to display equations (A) as the equations for the calculation of the diagram part parameter, i.e., the calculation target and value (B) as calculation results (step S58), and returns the process back to step S52.

In step S52, if determining that the unknown diagram part parameters cannot be calculated (step S52: No), the CPU 25 determines whether the operation to terminate the learning support process is performed (step S61).

In step S61, if determining that the operation to terminate the learning support process is not performed (step S61: No), the CPU 25 returns the process back to step S1 in FIG. 3; otherwise (step S61: Yes), the CPU 25 terminates the learning support process.

### Operation Example

The following details the operation of the display terminal 1 referring to the accompanying drawings.

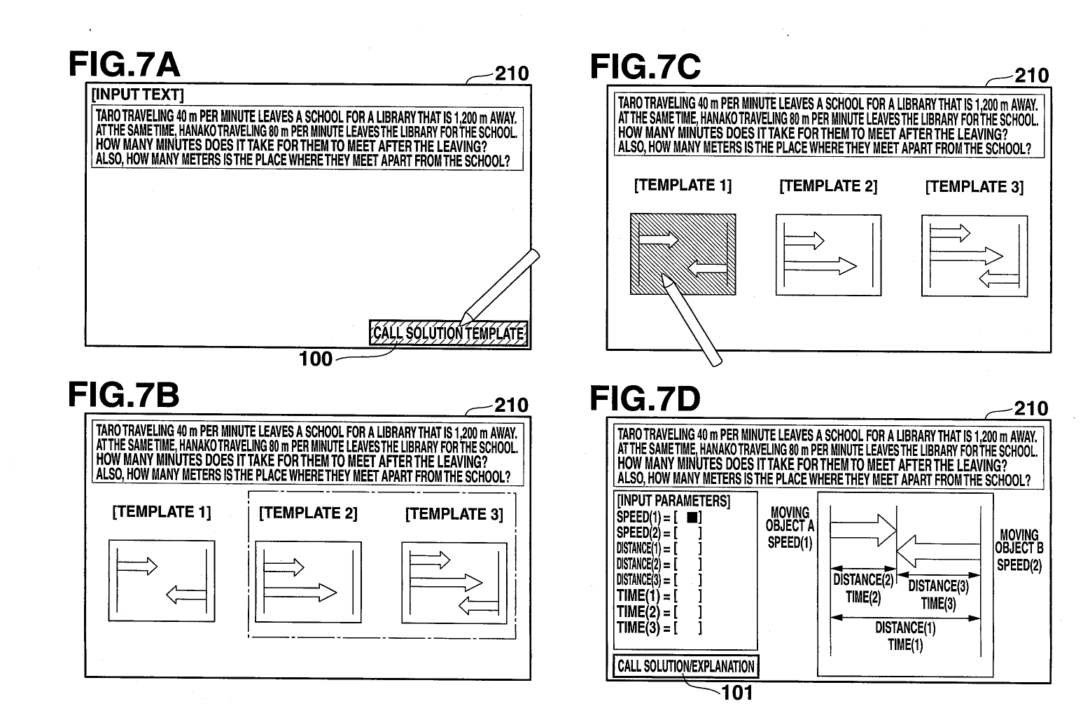

If a user selects a word problem from the teaching material database 241 (step S1: Yes), the selected word problem is displayed on the display 210 (step S2), as illustrated in FIG. 7A.

In this exemplary operation, the display 210 also displays a solution template call icon 100 used to display diagram templates.

Then, if the user touches the solution template call icon 100, the text of the word problem is parsed (step S3) and then the variable “m” is set to “2,” which is the number of types of moving objects, such as “Taro” and “Hanako,” in the same text (step S4).

Then, the variable “n” is set to “1,” which is the number of types of [numerical value+distance unit] terms, such as “1,200 m,” in the same text (step S5).

Then, the variable “o” is set to “1,” which is the number of [numerical value+distance unit] terms, such as “1,200 m,” in the same text (step S6).

Then, the variable “p” is set to “1,” which is the number of types of [numerical value+speed unit] terms, such as “40 m per min” and “80 m per min,” in the same text (step S7).

Then, the variable “q” is set to “2,” which is the number of [numerical value+speed unit] terms, such as “40 m per min” and “80 m per min,” in the same text (step S8).

Then, the variable “r” is set to “0,” which is the number of types of [numerical value+time unit] terms in the same text (step S9).

Then, the variable “s” is set to “0,” which is the number of [numerical value+time unit] terms in the same text (step S10).

Then, it is determined that a counterdirectional expression “meet” is included in the same text (step S11: Yes) and the variable “t” is set to “1” (step S12).

Then, it is determined that an equidirectional expression is not included in the same text (step S14: No) and the variable “u” is set to “0” (step S16).

Then, it is determined that a delay expression is not included in the same text (step S17: No) and the variable “v” is set to “0” (step S19).

Then, it is determined that a precedence expression is not included in the same text (step S20: No) and the variable “w” is set to “0” (step S22).

Then, after the comparison of the set variables “m” to “w” with each set of variables “m” to “w” preliminarily stored as identifying items in the diagram template table 242 (step S30), some of the sets of identifying items are extracted in descending order of the degrees of coincidence with the set variables “m” to “w.” Then, the thumbnails of the diagram templates corresponding to the extracted respective sets of identifying items are displayed on the display 210 in the order of the extraction (step S31), as illustrated in FIG. 7B. It should be noted that the diagram templates enclosed by the dash-dot lines in FIG. 7B are not displayed if only the thumbnail of the diagram template corresponding to a set of identifying items having the highest degree of coincidence with the set variables “m” to “w” is displayed.

Then, if the user selects a thumbnail (step S32: Yes), as illustrated in FIGS. 7C and 7D, the diagram template corresponding to the selected thumbnail is displayed on the display 210 (step S41). In this exemplary operation, the display 210 also displays a solution/explanation call icon 101 used to display hints.

Then, known variables “40,” “80,” and “1,200” are detected for the diagram part parameters in the corresponding diagram template, that is, “Speed I” (the length of right-pointing arrow “Speed I”), “Speed II” (the length of left-pointing arrow “Speed II”), “Distance I” (the length of two-directional arrow “Distance I”), respectively (step S42). Note that Roman numerals “I,” “II,” etc. herein associated with the diagram part parameters are replaced with Arabic numerals in parentheses in FIGS. 7A to 10B.

Then, the number of required known variables associated with the corresponding diagram template, “3,” is read out from the diagram template table 242 and assigned to the variable “X” (step S43).

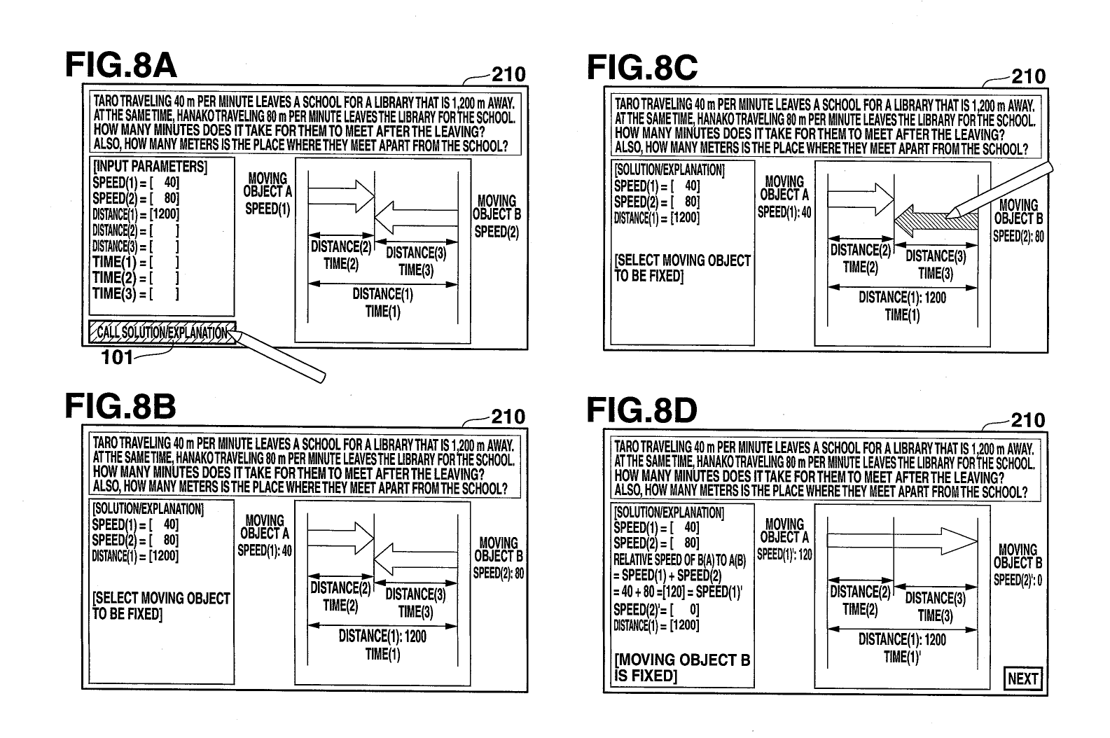

Then, if the user defines the diagram part parameter “Speed I” in the corresponding diagram template as a known parameter and inputs the corresponding known parameter “40” (step S44: Yes), the variable “X” is reduced by “1” into “2” (step S47). Then, the value “40,” which is input as the diagram part parameter “Speed I,” is displayed on the display 210 as “Speed I” (step S48), as illustrated in FIG. 8A.

Then, similarly, if the user defines the diagram part parameters “Speed II” and “Distance I” in the corresponding diagram template as known parameters and inputs the corresponding known parameters “80” and “1,200” (step S44: Yes), the variable “X” is set to “0” (step S47). Then, the values “80” and “1,200,” which are respectively input as the diagram part parameters “Speed II” and “Distance I,” are displayed on the display 210 as “Speed II” and “Distance I” (step S48).

Then, the variable “X” is determined to be “0” (step S49: Yes) and diagram part parameter relations associated with the corresponding diagram template (see the row of No. 1 in FIG. 2) are read out from the diagram template table 242 (step S51).

Then, if the user touches the solution/explanation call icon 101, the display 210 displays a message requiring the user to specify any one of the moving objects in the text of the word problem as a fixed object.

Then, as illustrated in FIGS. 8B and 8C, if the user specifies one of the moving objects in the same text, “Hanako” (moving object “B” in the corresponding diagram template), as a fixed object (step S510: Yes), the specified moving object, “Hanako,” is determined to be a fixed object and the rest of the moving objects, “Taro,” to be a non-fixed object. Then, as illustrated in FIG. 8D, a relation about the unknown variables in the word problem is read out among the diagram part parameter relations associated with the corresponding diagram template, that is, a relation of “relative speed of B(A) to A(B)=Speed I+Speed II” is read out from the diagram template table 242 and displayed on the display 210 as a corresponding diagram part parameter relation (step S511). Also, the speed of the fixed object, “Hanako,” (=Speed II) is changed to 0 (=Speed II′) and the speed of the non-fixed object, “Taro,” (=Speed I) to “120 m per min” (=Speed I′=Speed I+Speed II=40+80), while the corresponding diagram part parameter relation of “relative speed of B(A) to A(B)=Speed I+Speed II” is changed to “relative speed of B(A) to A(B)=Speed I+Speed II=40+80=Speed I′.” In addition, the diagram parts of “Speed I” and “Speed II” in the corresponding diagram template are changed to “Speed I′” and “Speed II′,” respectively. The corresponding diagram part parameter relation displayed at this time will be used by the user as hints on the solution to the word problem.

Then, it is determined that the unknown diagram part parameters “Time I′” (the length of two-directional arrow “Time I′”), “Distance II” (the length of two-directional arrow “Distance II”), and “Distance III” (the length of two-directional arrow “Distance III”) in the corresponding relation can be calculated, on the basis of the known parameters “40,” “80,” and “1,200” of the respective diagram parts “Speed I,” “Speed II,” and “Distance I” in the corresponding diagram template and the diagram part parameter relation (step S52: Yes).

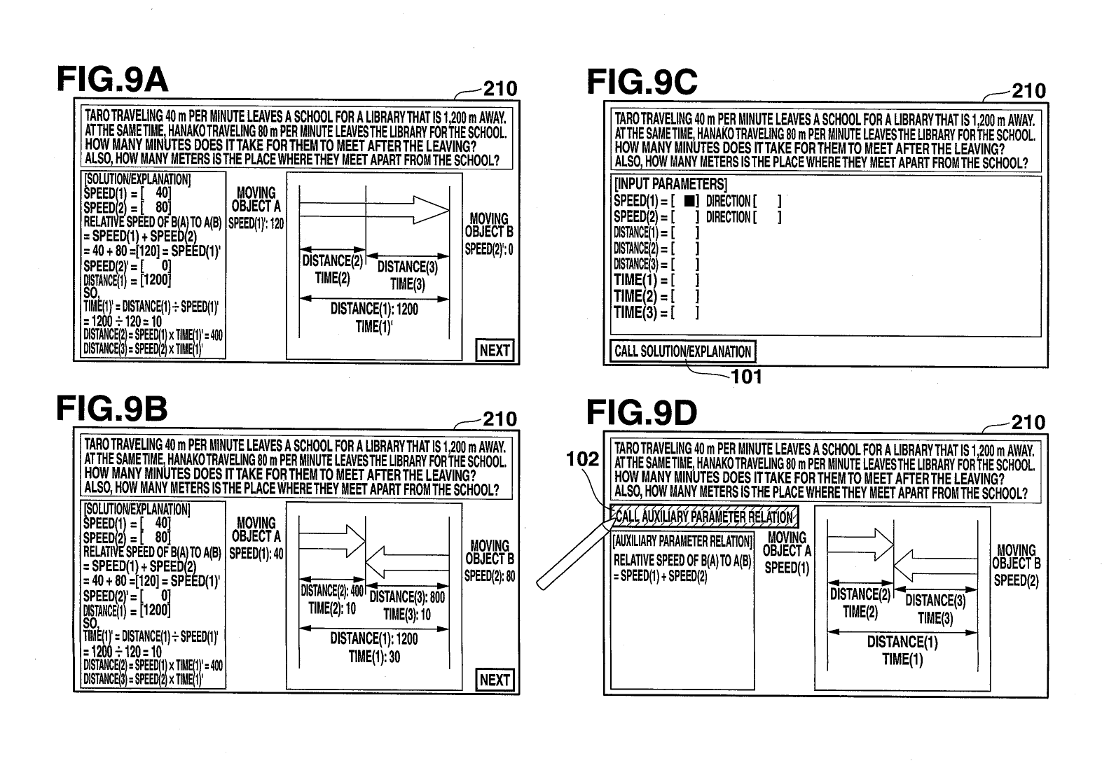

Then, the diagram part parameters “Time I′,” “Distance II,” and “Distance III” are determined as the diagram part parameters of the calculation targets, equations (A) “Time I′=Distance I/Speed I′,” “Distance II=Speed 1×Time I′,” and “Distance III=Speed II×Time I′” are created for the calculation of the diagram part parameters of the calculation targets, and the values (B) “10,” “400,” and “800” of the diagram part parameters “Time I′,” “Distance II,” and “Distance III,” respectively, are calculated (step S53). Equations (A) and values (B) are then displayed on the display 210 as illustrated in FIG. 9A (step S58).

In this operation example, if the user cancels the fixation of the moving object, the diagram parts of “Speed I′” and “Speed II′” in the corresponding diagram template are changed to “Speed I” and “Speed II,” respectively, as illustrated in FIG. 9B.

In summary, as illustrated in steps S4 to S22, S51, and S511 in FIGS. 3 to 6 and FIG. 7A to FIG. 9D, a set of identifying items is detected in the text of a displayed word problem and a relation associated with the detected set of identifying items is read out from the diagram template table 242 and displayed; thus, a relation corresponding to any displayed word problem is displayed as hints on a solution without the need for storing relations in association with each problem. Thus, efficient support for the study of word problems can be achieved compared with the conventional ways.

Furthermore, as illustrated in step S31 in FIG. 5 and FIGS. 7B to 7D, a diagram template corresponding to a detected set of identifying items is read out from the diagram template table 242 and displayed; hence, the diagram template matching with a displayed word problem is displayed as hints on a solution without the need for storing a diagram template in association with each problem. Thus, more efficient support for the study of word problems can be achieved.

In addition, as illustrated in steps S510 to S511 in FIG. 6 and FIGS. 8C and 8D, if any one of the multiple moving objects in a word problem is specified as a fixed object and the rest of the moving objects is (are) specified as a non-fixed object (s), then the speed value of the fixed object is changed to 0 and the speed value (s) of the non-fixed object (s) is (are) changed to a value (s) obtained as relative speed (s) thereof to the fixed object, and thus the corresponding relation is changed for display, which can lead to better understanding of the solutions to word problems involving multiple moving objects.

It should be appreciated that the detailed configuration and operation of each component of the display terminal 1 in the above embodiment may be modified as appropriate without deviating from the gist of the present invention.

Although the identifying items in the above embodiment are expressed in numerical values as shown in FIG. 2, a part of or all of the identifying items may be expressed in any other form as long as the identifying items can be used to identify the type of word problem.

Although the identifying items in the above embodiment include the values representing the number (of types) of [numerical value+distance unit] terms, the number (of types) of [numerical value+speed unit] terms, and the number (of types) of [numerical value+time unit] terms; the identifying items are not limited thereto. The identifying items may be related to other units or counter words other than “distance unit”, “speed unit” and “time unit”.

Although the display terminal 1 has been described as a learning support device according to the present invention, the present invention may be applied to any other product. Specifically, this invention is generally applicable to the electronic devices such as scientific electronic calculators, mobile phones, personal computers, personal digital assistants (PDAs), and game machines. Furthermore, the learning support program 240 according to the present invention may also be stored in a memory card or a CD, which are removable from the display terminal 1.

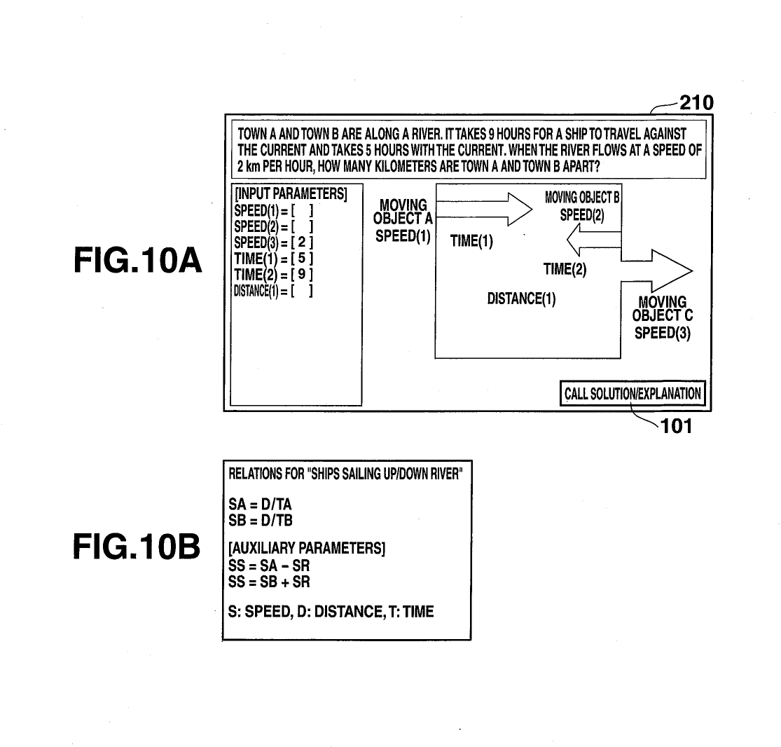

Examples of the diagram template include a diagram adapted to calculation about ships sailing up and down a river, as illustrated in FIG. 10A, in addition to calculation about travelers as illustrated in FIG. 2 and FIG. 7C. In such a ship case, equations for calculation about ships sailing up/down a river as illustrated in FIG. 10B are used as relations between diagram part parameters.

Alternatively, only variables corresponding to diagram part parameters may be displayed without a diagram template corresponding to a set of identifying items detected in the text of a word problem. In such a case, the contents of FIG. 9C, for example, are displayed instead of those of FIG. 7D. Note that “Directions” adjacent to “Speed I” and “Speed II” in FIG. 9C indicate the directions of the moving objects traveling with these speeds, and +/− signs or arrows indicating the directions are put in the brackets of “Directions.”

Although the above-described corresponding diagram part parameter relation is displayed after the user selects the corresponding diagram template and inputs the diagram part parameters of the template, the input of the parameters and display of the relation may also be carried out in different ways. For example, as illustrated in FIG. 9D, a corresponding diagram part parameter relation may be displayed after the selection of a corresponding diagram template and a predetermined operation by the user, and then the user may input diagram part parameters of the template. In the example illustrated in FIG. 9D, the selection of the corresponding diagram template by the user allows the corresponding diagram template and a relation display icon 102 used to display the corresponding diagram part parameter relation to be displayed. The touch of the relation display icon 102 by the user allows the corresponding diagram part parameter relation to be displayed.

Although some embodiments of the present invention have been described, they should not be construed as limitations on the scope of the present invention, which includes the scope of the invention set forth in the following claims and equivalents thereto.

The entire disclosure of Japanese Patent Application No. 2012-202364 filed on Sep. 14, 2012 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A learning support device comprising:
a storage unit which stores a plurality of identifying items to identify a type of a word problem, the identifying items being detectable in a text of the word problem, and stores at least one relation between variables in the word problem, the type of which is identified by the identifying items, the storage unit storing the identifying items and the at least one relation for each type of the word problem;
a first display control unit which displays the word problem requiring calculation of an unknown variable not specified in the text from known variables specified in the text;
a detecting unit which detects each of the identifying items in the text of the word problem displayed by the first display control unit; and
a second display control unit which reads out, from the storage unit, a relation about the unknown variable among the at least one relation for the word problem, the type of which is identified by the identifying items detected by the detecting unit, and which displays the read-out relation as a corresponding relation.

2. The learning support device according to claim 1,
wherein the identifying items include at least one of a number of quantitative expressions, a number of types of the quantitative expressions, and presence or absence of a specific expression which are specified in the text.

3. The learning support device according to claim 1,
wherein the storage unit stores a diagram template diagrammatically representing the word problem, the type of which is identified by the identifying items;
wherein the second display control unit reads out, from the storage unit, the diagram template corresponding to the identifying items detected by the detecting unit and displays the read-out diagram template as a corresponding diagram template; and
wherein the diagram template diagrammatically represents the word problem, the type of which is identified by the corresponding identifying items, so that the known variables and the unknown variable in the word problem are associated with diagram part parameters each representing any one of a length, an angle and an area of a diagram part of the diagram template.

4. The learning support device according to claim 1,
wherein the word problem involves a plurality of moving objects;
wherein the learning support device further comprises a specifying unit which specifies one of the moving objects as a fixed object and specifies a rest of the moving objects as a non-fixed object according to user operations; and
wherein the second display control unit changes a speed value of the fixed object to 0 and changes a speed value of the non-fixed object to a value obtained as a relative speed of the non-fixed object to the fixed object to change the corresponding relation, and displays the changed corresponding relation.

5. A learning support method for a computer including a storage unit which stores a plurality of identifying items to identify a type of a word problem, the identifying items being detectable in a text of the word problem, and stores at least one relation between variables in the word problem, the type of which is identified by the identifying items, the storage unit storing the identifying items and the at least one relation for each type of the word problem, the method comprising:
displaying the word problem requiring calculation of an unknown variable not specified in the text from known variables specified in the text;
detecting each of the identifying items in the text of the displayed word problem; and
reading out, from the storage unit, a relation about the unknown variable among the at least one relation for the word problem, the type of which is identified by the detected identifying items, and displaying the read-out relation as a corresponding relation.

6. A non-transitory storage medium containing a learning support program to be executed by a computer including a storage unit which stores a plurality of identifying items to identify a type of a word problem, the identifying items being detectable in a text of the word problem, and stores at least one relation between variables in the word problem, the type of which is identified by the identifying items, the storage unit storing the identifying items and the at least one relation for each type of the word problem, the program making the computer realize functions of:
a first display control unit which displays the word problem requiring calculation of an unknown variable not specified in the text from known variables specified in the text;
a detecting unit which detects each of the identifying items in the text of the word problem displayed by the first display control unit; and
a second display control unit which reads out, from the storage unit, a relation about the unknown variable among the at least one relation for the word problem, the type of which is identified by the identifying items detected by the detecting unit, and which displays the read-out relation as a corresponding relation.
